(19) United States
(12) Patent Application Publication
(10) Pub. No.: US 2015/0352708 A1
(43) Pub. Date: Dec. 10, 2015

(54) TOOL MOUNTING DEVICE

(71) Applicant: HILTI AKTIENGESELLSCHAFT, Schaan (LI)

(72) Inventor: John Van Taack-Trakranen, Muenchen (DE)

(21) Appl. No.: 14/764,467

(22) PCT Filed: Jan. 28, 2014
(86) PCT No.: PCT/EP2014/051626

§ 371 Date: Jul. 29, 2015

(30) Foreign Application Priority Data
Jan. 31, 2013 (DE) 10 2013 201 612.3

(51) Int. Cl. B25H 1/12; B25H 1/00; F16M 11/04

(52) U.S. Cl. CPC B25H 1/12; F16M 11/046; B25H 1/0042

(57) ABSTRACT

An appliance mounting device (10) for fixing at least one appliance, in particular a machine tool, to a machine support (20) is provided. The appliance mounting device (10) contains a coupling device (30) with a first coupling device end (32), a second coupling device end (34), an upper coupling device end (36), a lower coupling device end (38), a first hook (44) and a second hook (46). The coupling device (30) can be coupled to a guide carriage (80) of the machine support (20), the first hook (44) and the second hook (46) being positioned on the upper coupling device end (36). The coupling device (30) includes at least one first integrating element (50) which can be integrated into a first receiving opening element (90) of the guide carriage (80).

The present invention relates to a tool mounting device for attaching at least one tool, in particular a machine tool, to a machine stand. The tool mounting device contains a coupling device including a first coupling device end, a second coupling device end, an upper coupling device end, a lower coupling device end, a first hook and a second hook. The tool mounting device may be coupled to a guide carriage of the machine stand, the first hook and the second hook being positioned on the upper coupling device end.

Furthermore, the present invention relates to a guide carriage for accommodating a tool mounting device, which may be positioned along a machine stand. The guide carriage contains a receiving opening for accommodating a coupling device of the tool mounting device, the receiving opening having a first receiving end and a second receiving end.

Furthermore, the present invention relates to a system containing a tool mounting device and a guide carriage.

### BACKGROUND

Usually, a machine stand rig is made up of a stand set up perpendicularly to the particular subfloor, the stand having a row of teeth on one of its outer surfaces. Thus the stand essentially has the shape of a gear rack. Furthermore, the machine stand rig normally has a broad stand base, on which the stand is attached and which, appropriate to the possible use of the machine stand rig, may be fixedly joined to the subfloor. Moreover, the machine stand rig normally has a guide carriage having at least one gear wheel, which engages in the teeth of the gear rack of the stand (rack and pinion drive principle). The guide carriage is positioned on the stand. With the aid of this rack and pinion drive as well as an appropriate control device, for example, a hand wheel, the guide carriage may be moved vertically along the stand, making it possible to vary the height of the guide carriage. The guide carriage also usually includes a receiving opening for accommodating and holding a coupling device which is part of a tool mounting device. The tool mounting device is usually attached directly to the housing of a machine tool.

Such a machine stand rig is known, for example, from unexamined German patent application DE 10 2007 055 716. In this regard, this document describes a machine stand including a guide carriage. A machine coupling, on which a portable machine tool may be attached, is located on the guide carriage. In addition, a carriage coupling part having a clamping surface is situated on the guide carriage. A machine coupling part for a machine tool having a clamping surface is in turn assigned to the carriage coupling part and may be coupled to it. The machine coupling part has two at least partially circumferentially exposed pins, which may be engaged behind two connectably assigned hooks of the carriage coupling part. A hook may be displaced along its clamping surface in the carriage coupling part.

Furthermore, unexamined German patent application DE 32 37 057 describes a stand drilling tool having a vertically oriented column, a carriage and a tool support attached to the carriage. For that reason, a guide profile is provided on this tool support and multiple guide surfaces are provided on the carriage for attaching the tool support onto the carriage. One of these guide surfaces is formed by the clamping area of a retractable eccentric pin. On its expanded end, a guide profile supports a catching nose which projects beyond the clamping area by the degree of advancement of the eccentric pin.

As shown, for example, in unexamined German patent application 32 37 057, the vertical positioning of a tool on the tool support is carried out using inclined stops on the tool support. The orientation in the plane parallel to the front edge of the column and perpendicular to the subfloor is carried out using the planar surface provided for this purpose. The orientation perpendicular to this, which is intended to prevent rotation on the planar surface, is ensured by planar surfaces to the side of the gear housing as well as appropriate counter-surfaces on the carriage.

In the case of conventional machine stands, the problem exists in particular that the planar surface of the carriage for accommodating the tool support is usually larger than the planar surface of the tool support, which is attached to the planar surface of the carriage. As a result of the manufacturing and to make it simple to attach the tool support on the carriage, therefore, a certain freedom of movement or a certain play is provided between the tool support and the carriage, which, however, makes it impossible to achieve an exact fit between these components. Due to this low fitting accuracy, the tool support and the carriage are able to rotate against one another, resulting in greater wear on the planar and contact surfaces of the two components.

In the existing embodiment of the carriage and the tool support for the mutual attachment, considerable effort must also be put into machining. Among other things, the counterpart of the previous centering in the carriage requires a lateral step in order to maintain the lateral stability of the tool support and center it. This means that an additional lateral machining for this step is required for machining the planar surface on the carriage, resulting in increased manufacturing costs. The fact that the planar surfaces on the gear housing, which are provided for the lateral stability and centering, are frequently exposed and may therefore be damaged easily, must be seen as an additional disadvantage. Moreover, a problem exists in the fact that dirt is able to accumulate in the corners between the planar surfaces for the lateral centering, which has a negative impact on the orientation and attachment of the tool support to the carriage.

### SUMMARY OF THE INVENTION

It is an object of the present invention to provide a tool mounting device for attaching at least one tool, in particular a machine tool, to a machine stand. The tool mounting device includes in this connection a coupling device including a first coupling device end, a second coupling device end, an upper coupling device end, a lower coupling device end, a first hook and a second hook. The first and second hooks may be coupled to a guide carriage of the machine stand, the first hook and the second hook being positioned on the upper coupling device end.

The present invention provides a coupling device including at least one first integrating element, the first integrating element being integratable into a first receiving opening element of the guide carriage.

According to another embodiment of the present invention, the at least first integrating element may be positioned on the first coupling device end.

Furthermore, the at least first integrating element may be positioned on the lower coupling device end.

In order to produce a contact surface between the integrating element and the receiving opening element of the guide carriage, the at least first integrating element may contain at least one first integrating contact surface.

According to yet another advantageous embodiment, it may be provided that the at least first integrating contact surface is diametrically opposed to at least a first receiving contact surface, when the coupling device is integrated into the receiving openings of the guide carriage. It is in this connection possible that in the integrated state, a certain distance exists between the first integrating contact surface and the first receiving contact surface. It is, however, also possible that the at least first integrating contact surface abuts on at least a first receiving contact surface or that the at least first integrating contact surface is in contact with at least a first receiving contact surface.

An alternate or additional object of the present invention is to solve the problems and disadvantages described above by providing a guide carriage for accommodating a tool mounting device, which may be positioned along a machine stand. The guide carriage contains for that purpose a receiving opening for accommodating a coupling device of the tool mounting device, the receiving opening having a first receiving end and a second receiving end.

According to the present invention, the receiving opening contains at least one first receiving opening element for accommodating at least a first integrating element of the coupling device of the tool mounting device.

According to another advantageous embodiment of the present invention, the at least first receiving opening element may be positioned on the first receiving end.

In order to produce a level contact surface between the integrating element and the receiving opening element of the guide carriage, the at least first receiving opening element may contain at least one first receiving contact surface.

According to yet another advantageous embodiment, it may be provided that the at least first receiving contact surface is diametrically opposed to at least a first integrating contact surface, when the coupling device is integrated into the receiving openings of the guide carriage. It is in this connection possible that in the integrated state, a certain distance exists between the first receiving contact surface and the first integrating contact surface. It is, however, also possible that the at least first receiving contact surface abuts on at least a first integrating contact surface or that the at least first receiving contact surface is in contact with at least a first integrating contact surface.

Another additional or alternate object of the present invention is to solve the problems and disadvantages described above by providing a system which contains a tool mounting device and a guide carriage.

### BRIEF DESCRIPTION OF THE DRAWINGS

Further advantages ensue from the following description of the drawings. An exemplary embodiment of the present invention is shown in the drawings. The drawings, the description and the claims contain numerous features in combination. Those skilled in the art will advantageously also consider the features individually and combine them into meaningful additional combinations.

FIG. 1 shows a first perspective view of a tool mounting device according to the present invention on the housing of a core drill;

FIG. 2 shows a second perspective view of the tool mounting device according to the present invention on the housing of a core drill;

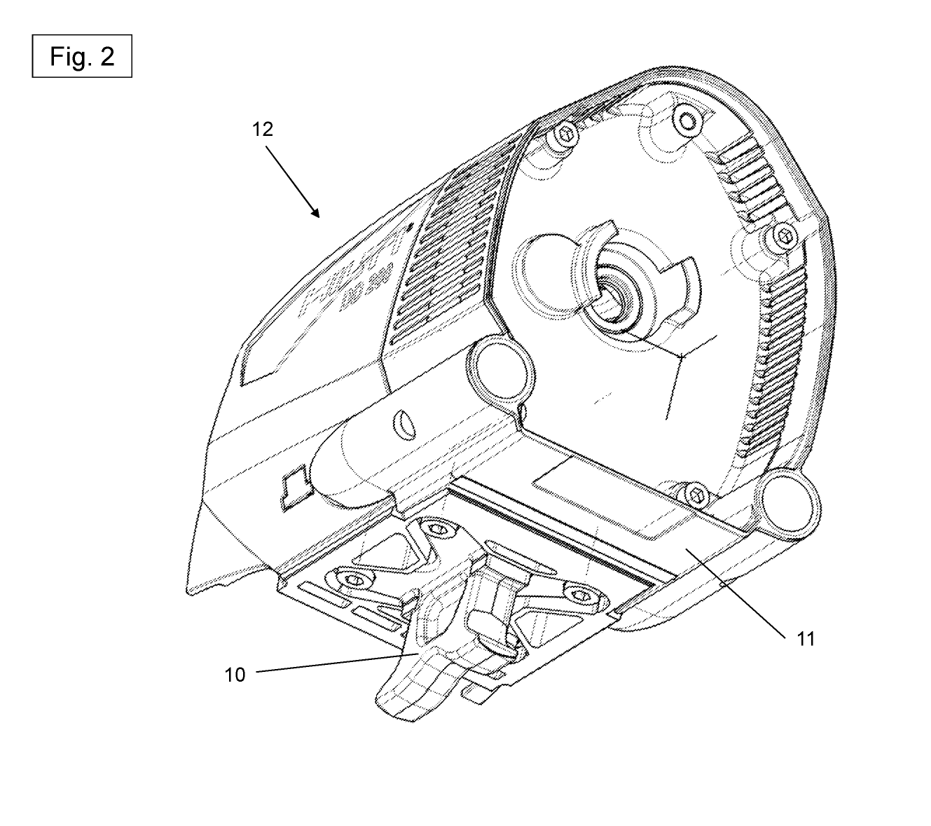

FIG. 3 shows a bottom view of the tool mounting device according to the present invention on the housing of a core drill;

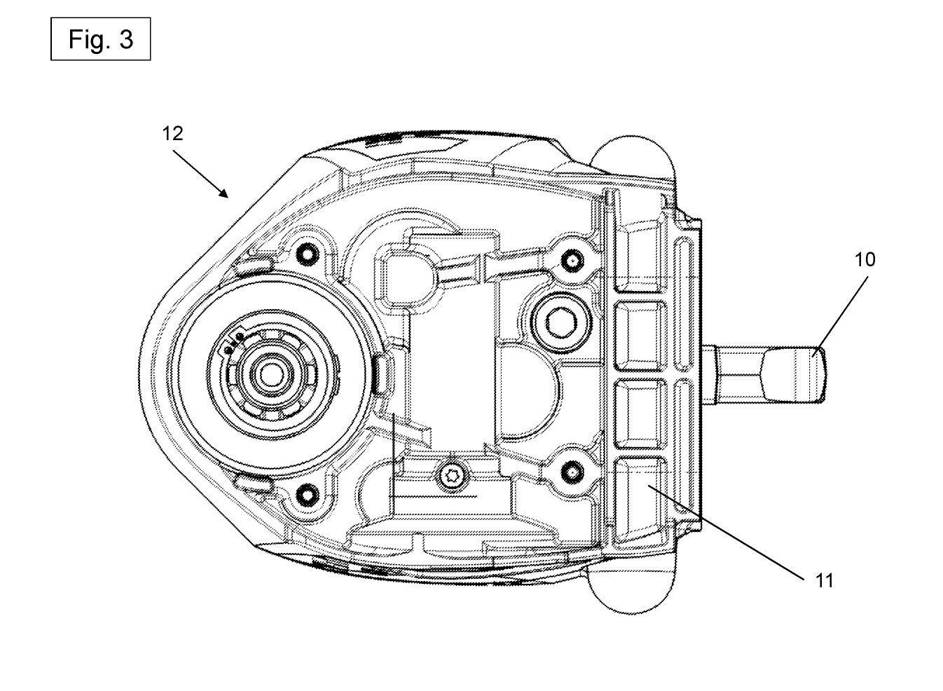

FIG. 4 shows a side view of the tool mounting device according to the present invention on the housing of a core drill;

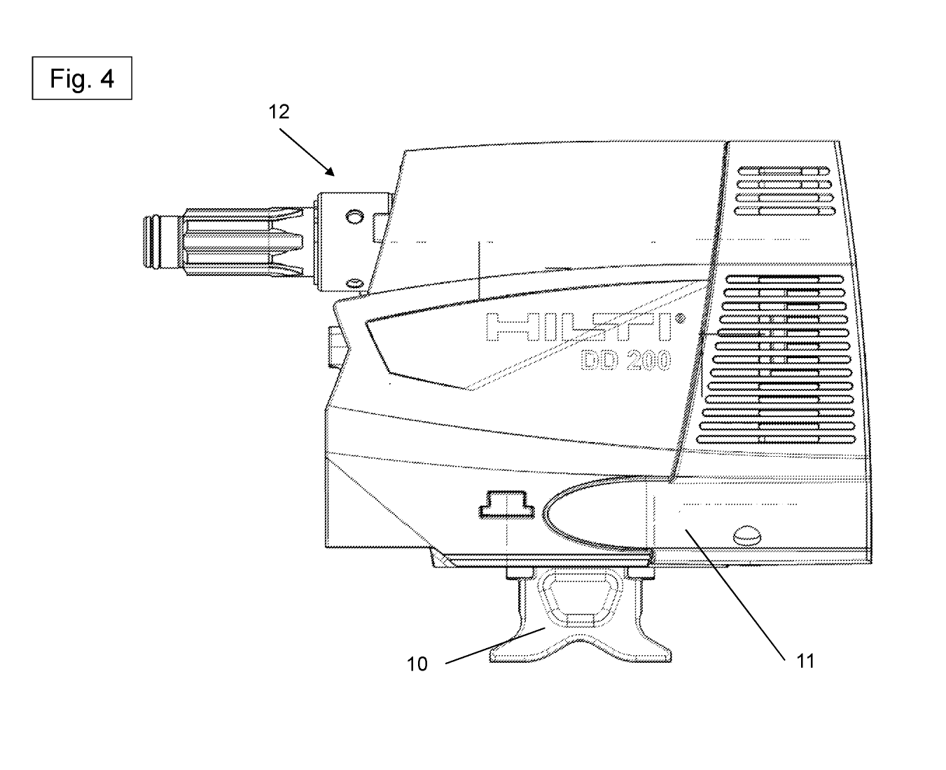

FIG. 5 shows a front view of the tool mounting device according to the present invention on the housing of a core drill;

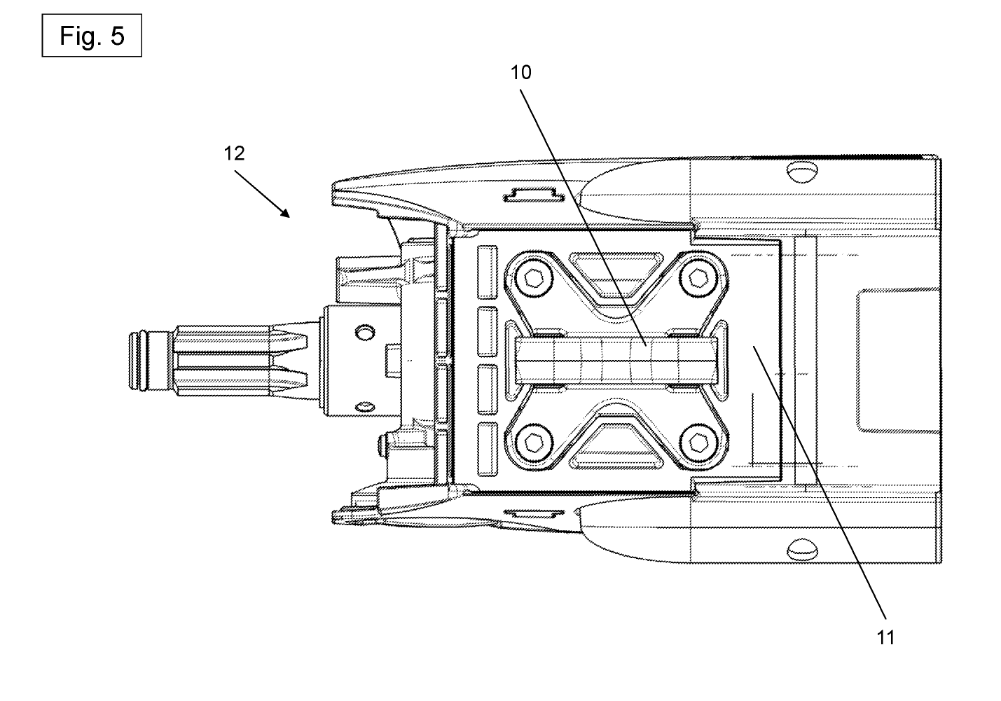

FIG. 6 shows a first perspective detailed view of the tool mounting device according to the present invention including the coupling device;

FIG. 7 shows a second perspective detailed view of the tool mounting device according to the present invention including the coupling device;

FIG. 8 shows a top view of the tool mounting device according to the present invention including the coupling device;

FIG. 9 shows a front view of the tool mounting device according to the present invention including the coupling device;

FIG. 10 shows a side view of the tool mounting device according to the present invention including the coupling device;

FIG. 11 shows a top view of a guide carriage according to the present invention including a receiving opening;

FIG. 12 shows a perspective view of the guide carriage according to the present invention including the receiving opening;

FIG. 13 shows a perspective view of a machine stand including the guide carriage according to the present invention; and

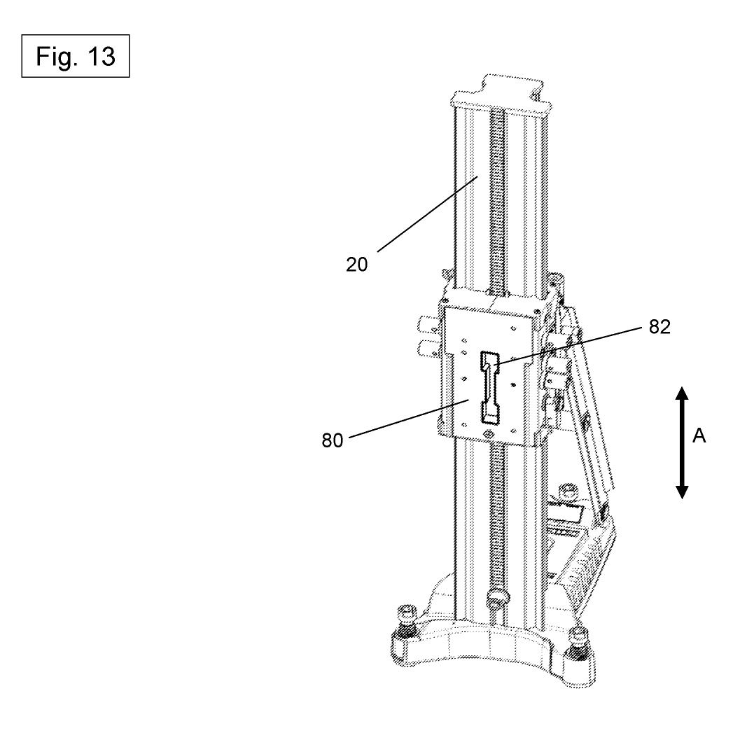

FIG. 14 shows a side view of a system according to the present invention containing a machine stand, the tool mounting device according to the present invention and the guide carriage according to the present invention.

### DETAILED DESCRIPTION

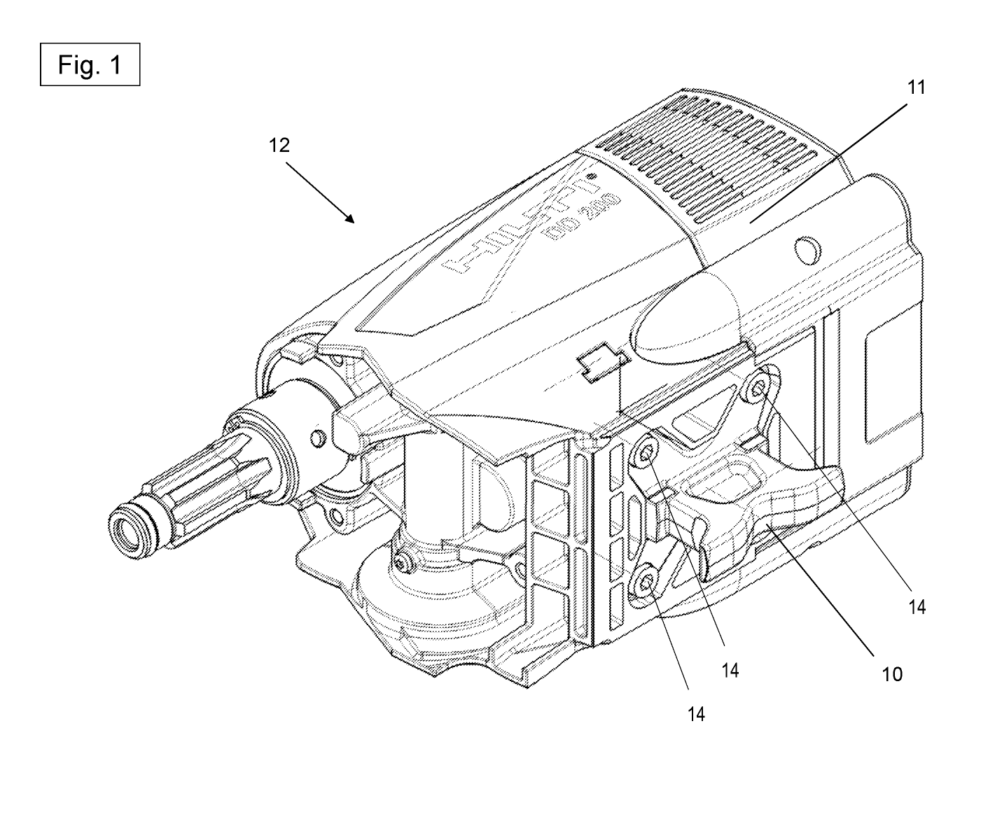

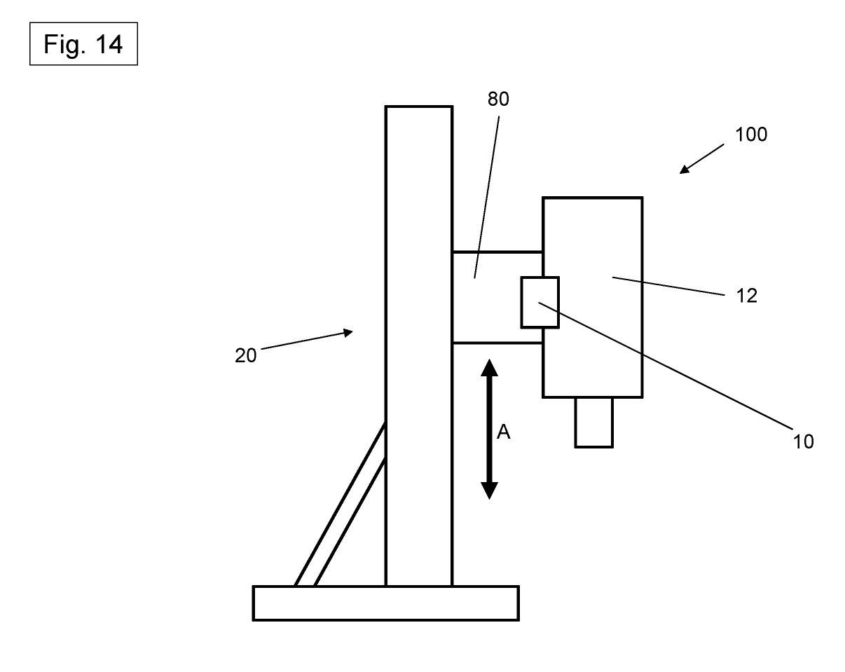

FIG. 1 shows tool mounting device 10, which is attached to housing 11 of a core drill 12 with the aid of four screws 14. Tool mounting device 10 is used for attaching core drill 12 to a machine stand 20, so that core drill 12 is movably guided by machine stand 20 in a horizontal direction (arrow A) (see FIG. 14).

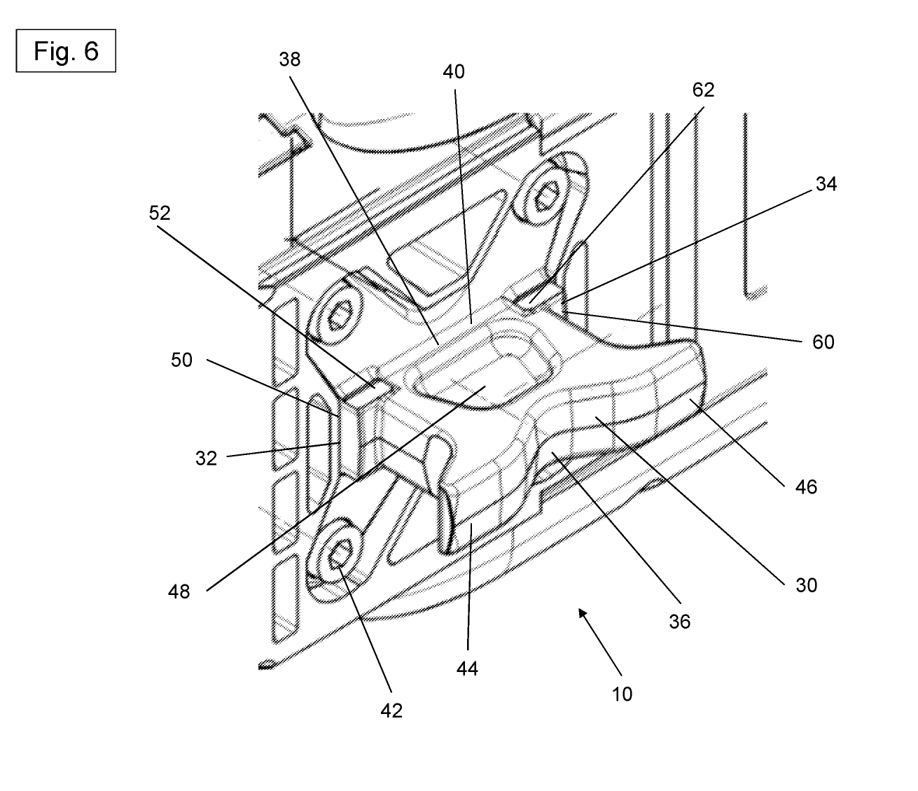

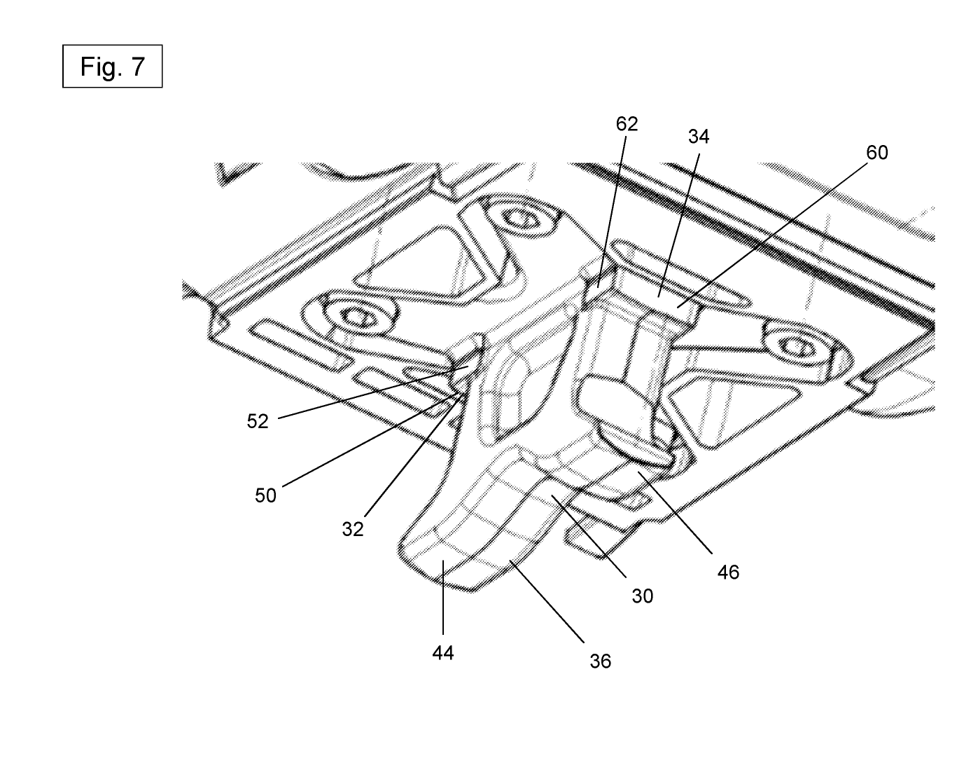

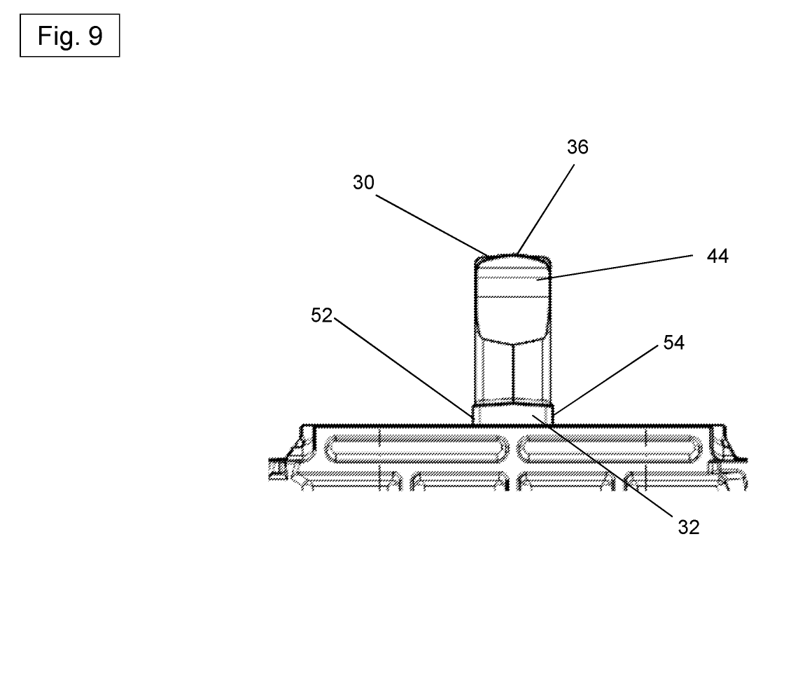

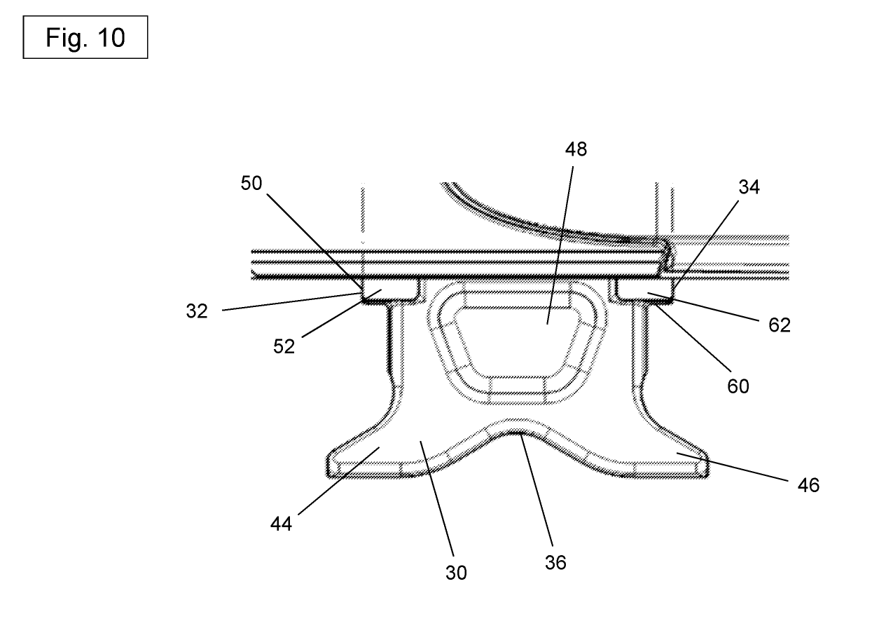

Tool mounting device 10 contains a coupling device 30 including a first coupling device end 32 and a second coupling device end 34 (FIGS. 6, 7, 8, 9, 10).

Furthermore, tool mounting device 10 contains, as shown in FIG. 6, an upper coupling device end 36 and a lower coupling device end 38. On lower coupling device end 38, tool mounting device 10 contains a foot device 40 including four uniformly distributed foot elements 42. On upper coupling device end 36 are positioned a first hook 44 and a second hook 46, which may be coupled to a guide carriage 80 of machine stand 20, which will be described in greater detail later. Coupling device 30 moreover has a central recess 48 in order to save weight.

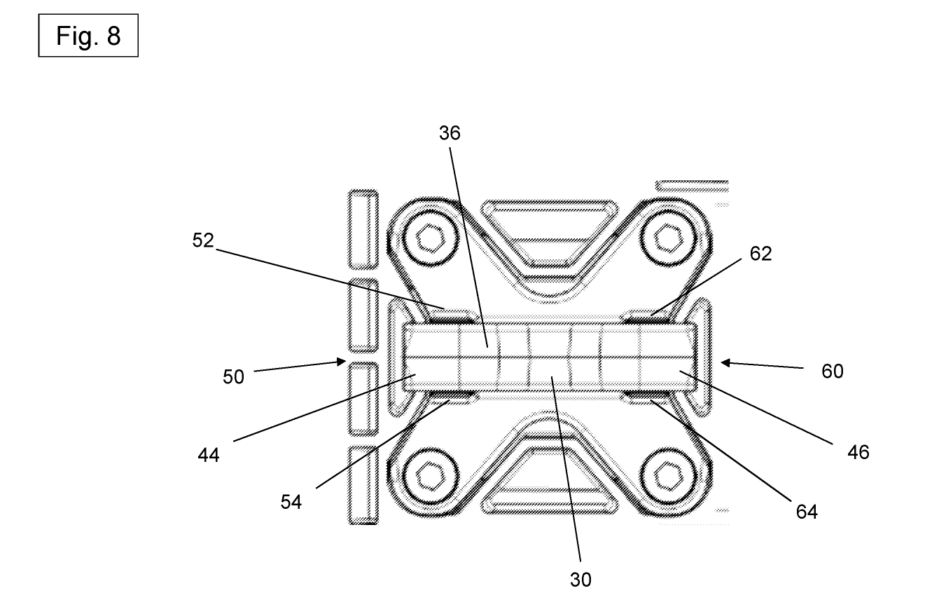

As also shown in FIGS. 6 and 8, coupling device 30 also contains a first integrating element 50 and a second integrating element 60. Both integrating elements 50, 60 are essentially designed in the form of a flat cuboid. First integrating element 50 contains a first integrating contact surface 52 and a second integrating contact surface 54; both integrating contact surfaces 52, 54 lie on or abut the diametrically opposed sides of first integrating element 50. Second integrating element 60 in turn contains a first integrating contact surface 62 and a second integrating contact surface 64. As in the case of first integrating element 50, both integrating contact surfaces 62, 64 in the case of second integrating element 60 also lie on or abut the diametrically opposed sides of this second integrating element 60.

First integrating element 50 is positioned on first coupling device end 32 and second integrating element 60 is in turn positioned on second coupling device end 34. Both first integrating element 50 and second integrating element 60 are located in the vicinity of lower coupling device end 38, however, above foot device 40.

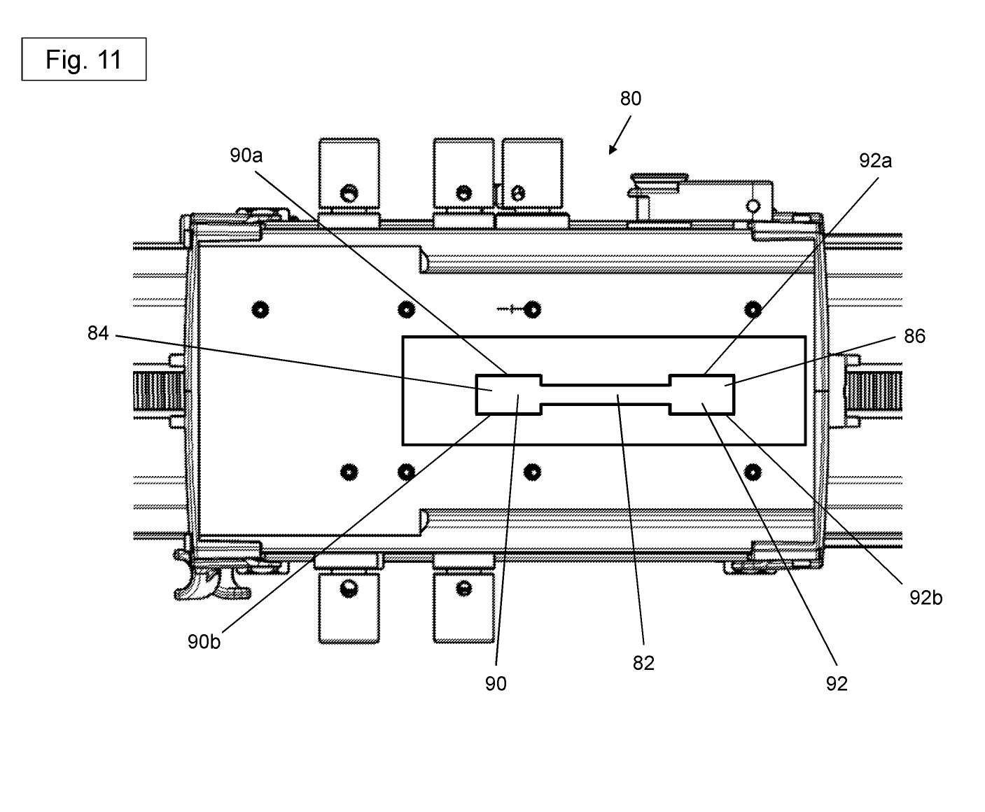

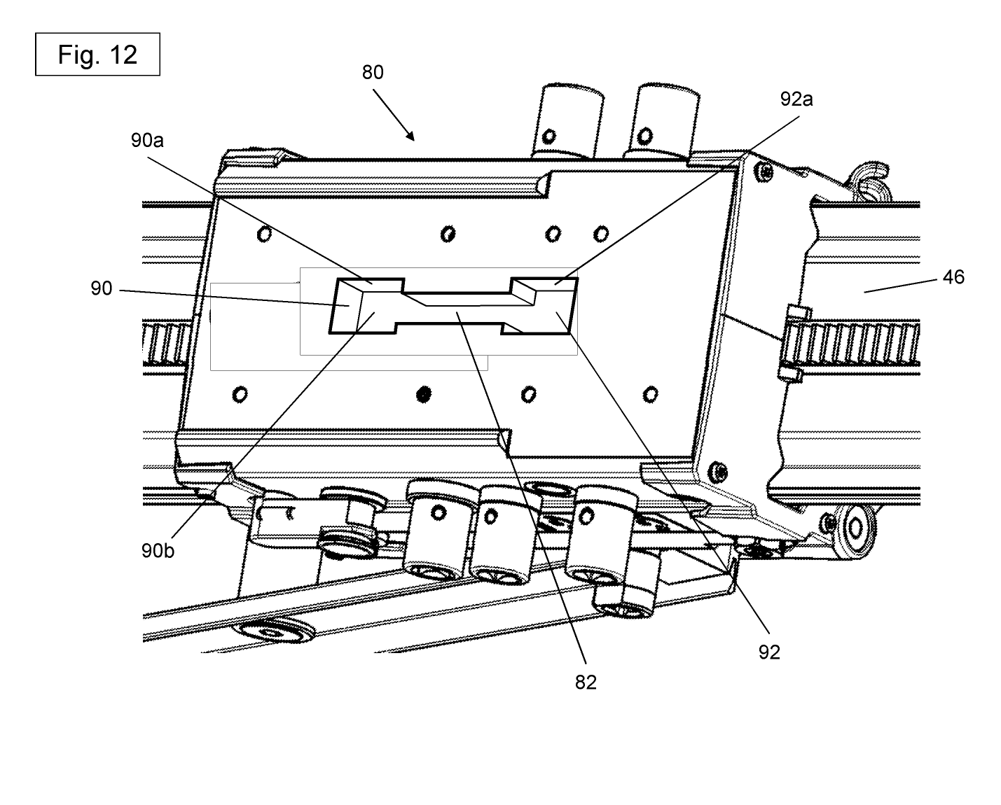

FIGS. 11 and 12 show a guide carriage 80, which is used to accommodate an above-described tool mounting device 10 and position it along a machine stand 20. Guide carriage 80 contains for that purpose a receiving opening 82 for accommodating coupling device 30 of tool mounting device 10. Receiving opening 82 has a first receiving end 84 and a second receiving end 86. Furthermore, receiving opening 82 contains at least one first receiving opening element 90 and a second receiving opening element 92. First receiving opening element 90 is used for accommodating first integrating element 50 of coupling device 30 of tool mounting device 10, and second receiving opening element 92 is used in turn for accommodating second integrating element 60 of coupling device 30 of tool mounting device 10. First receiving opening element 90 is positioned on first receiving end 84 and contains a first receiving contact surface 90a and a second receiving contact surface 90b. Second receiving opening element 92 is positioned on second receiving end 86 and contains a first receiving contact surface 92a and a second receiving contact surface 92b.

First receiving contact surface 94 of first receiving opening element 90 is designed in such a way that it abuts on or is in contact with first integrating contact surface 62, and second receiving contact surface 96 of first receiving opening element 90 is designed in such a way that it abuts on or is in contact with second integrating contact surface 64, when coupling device 30 is integrated into receiving openings 82 of guide carriage 80.

FIG. 14 shows a system 100, which contains the above-described tool mounting device 10 as well as guide carriage 80, which is also described above.

For attaching tool mounting device 10 to guide carriage 80, coupling device 30 is integrated into receiving opening 82 in such a way that first integrating contact surface 52 of first integrating element 50 is in contact with or abuts on first receiving contact surface 90a of first receiving opening element 90 and second integrating contact surface 54 of first integrating element 50 is in contact with or abuts on second receiving contact surface 90b of first receiving opening element 90. Furthermore, first integrating contact surface 62 of second integrating element 60 is in contact with or abuts on first receiving contact surface 92a of second receiving opening element 92, and second integrating contact surface 64 of second integrating element 60 is in contact with or abuts on second receiving contact surface 92b of second receiving opening element 92.

What is claimed is:

1-10. (canceled)

11. A tool mounting device for attaching at least one tool to a machine stand, the mounting device comprising:
a coupling device including
a first coupling device end,
a second coupling device end,
an upper coupling device end,
a lower coupling device end,
a first hook and
a second hook;
the coupling device couplable to a guide carriage of the machine stand, the first hook and the second hook being positioned on the upper coupling device end, the coupling device containing at least one first integrating element, the first integrating element being integratable into a first receiving opening element of the guide carriage.

12. The tool mounting device as recited in claim 11 wherein the at least first integrating element is positioned on the first coupling device end.

13. The tool mounting device as recited in claim 11 wherein the at least first integrating element is positioned on the lower coupling device end.

14. The tool mounting device as recited in claim 11 wherein the at least first integrating element (50) contains at least one first integrating contact surface.

15. The tool mounting device as recited in claim 14 wherein the at least first integrating contact surface is diametrically opposed to at least a first receiving contact surface, when the coupling device is integrated into receiving openings of the guide carriage.

16. A machine tool mounting device comprising the tool mounting device as recited in claim 11.

17. A guide carriage for accommodating a tool mounting device positionable along a machine stand, the guide carriage comprising:
a receiving opening for accommodating a coupling device of the tool mounting device, the receiving opening having a first receiving end and a second receiving end, the receiving opening including at least one first receiving opening element for accommodating at least a first integrating element of the coupling device of the tool mounting device.

18. The guide carriage as recited in claim 17 wherein the at least first receiving opening element is positioned on the first receiving end.

19. The guide carriage as recited in claim 17 wherein the at least first receiving opening element contains at least one first receiving contact surface.

20. The guide carriage as recited in claim 19 wherein the at least first receiving contact surface is diametrically opposed to at least a first integrating contact surface, when the coupling device is integrated into the receiving openings of the guide carriage.

21. A system comprising:
the tool mounting device as recited in claim 10; and
the guide carriage, the guide carriage including a receiving opening for accommodating the coupling device of the tool mounting device, the receiving opening having a first receiving end and a second receiving end, the receiving opening including the at least one first receiving opening element for accommodating at least the first integrating element of the coupling device of the tool mounting device.
